(19) United States
(12) Patent Application Publication
(10) Pub. No.: US 2012/0067149 A1
(43) Pub. Date: Mar. 22, 2012

(54) SLIP CONTROL DEVICE

(76) Inventors: Young Kwan Yoon, Gyeonggi-Do (KR); Seok Ho Shin, Gyeonggi-Do (KR)

(21) Appl. No.: 13/321,197

(22) PCT Filed: May 18, 2010
(86) PCT No.: PCT/KR10/03130

§ 371 Date: Nov. 18, 2011

(30) Foreign Application Priority Data
May 19, 2009 (KR) 10-2009-0043678

(51) Int. Cl. F16H 1/06; F16H 61/00

(52) U.S. Cl. 74/414

(57) ABSTRACT

A slip control device including a shaft fixed to a reference surface; a first gear rotatably coupled to the shaft by a predetermined friction force with respect to an external circumferential surface of the shaft, for slipping with respect to the shaft when applied a rotation force greater than the predetermined friction force; a friction unit configured to provide the predetermined friction force between the first gear and the shaft; a rotation gear box for covering at least one surface of the first gear, coupled to a second gear to be rotated around the external circumferential surface of the shaft, and for rotating about the shaft during rotation of the second gear; and a motor disposed in the rotation gear box and providing the second gear with a rotation force to rotate the rotation gear box about the first gear.

### TECHNICAL FIELD

The present invention relates to a slip control device, and more particularly, to a slip control device that slips when the slip control device stops rotating due to being obstructed by an obstacle.

### BACKGROUND ART

A variety of mounting devices are recently popular since flat display devices such as a flat panel computer monitor, an LCD, a PDP, and the like are main types of display devices. Of these mounting devices, a mounting device for automatically adjusting a rotational angle of a display device according to user convenience has been developed. However, rotation of the display device may injure a user.

### DISCLOSURE OF INVENTION

### Technical Problem

The present invention provides a slip control device for providing a safety device when rotation of a display device using the slip control device is interrupted by an obstacle, such as a user.

### Solution to Problem

According to an aspect of the present invention, there is provided a slip control device including: a shaft fixed to a reference surface; a first gear rotatably coupled to the shaft by a predetermined friction force with respect to an external circumferential surface of the shaft, for slipping with respect to the shaft when applied a rotation force greater than the predetermined friction force; a friction unit configured to provide the predetermined friction force between the first gear and the shaft; a rotation gear box for covering at least one surface of the first gear, coupled to a second gear to be rotated around the external circumferential surface of the shaft, and for rotating about the shaft during rotation of the second gear; and a motor disposed in the rotation gear box and providing the second gear with a rotation force to rotate the rotation gear box about the first gear.

The slip control device may further include: a support unit attached to the rotation gear box and for rotating during the rotation of the rotation gear box; a base bracket coupled to the support unit; and a mounting bracket pivotally coupled to the base bracket and for mounting a unit to be attached.

The shaft may include a fixing washer projection on an external contact surface thereof, wherein the friction unit includes: a friction adjustment nut screwed onto the shaft; a fixing washer disposed on one side of the friction adjustment nut and hooked on the fixing washer projection of the shaft; and a washer disposed on the shaft between the friction adjustment nut and the first gear and providing the first gear with the predetermined friction force.

The slip control device may further include: a control system for controlling a rotational angle of the support unit with respect to the reference surface, wherein the control system includes: a receiving unit for detecting a change in an angle of the support unit with respect to the reference surface; a control unit for receiving the change in the angle of the support unit with respect to the reference surface detected by the receiving unit and outputting a control value; and a driving unit for receiving the control value and rotating the motor, wherein the receiving unit includes: a second sensor gear mechanically engaged with an internal circumferential surface of a fixing gear located in the reference surface and rotating around the fixing gear during the rotation of the rotation gear box; a first sensor gear engaged with the second sensor gear and rotating around the second sensor gear; and a sensor mechanically coupled to the first sensor gear on a rotating axis of the first sensor gear, and detecting the change in the angle of the support unit with respect to the reference surface during rotation of the first sensor gear, wherein the sensor is disposed in the rotation gear box.

The first sensor gear may substantially rotate one full time each time the rotation gear box rotates by 15 degrees with respect to the reference surface.

The control unit may receive a command from a user, and operate the driving unit to rotate the support unit with respect to the reference surface, and, if a delay time in which a change in the angle of the support unit detected by the receiving unit does not occur is greater than a first reference value during the operation of the driving unit, stops operating the driving unit.

The control unit may receive a command from a user, and operate the driving unit to rotate the support unit in a direction with respect to the reference surface, and, if a delay time in which a change in the angle of the support unit detected by the receiving unit does not occur is greater than a second reference value during the operation of the driving unit, rotate the support unit in an opposite direction.

### BRIEF DESCRIPTION OF DRAWINGS

The above and other features and advantages of the present invention will become more apparent by describing in detail exemplary embodiments thereof with reference to the attached drawings in which:

FIG. 1 is a schematic exploded perspective view of a slip control device according to an embodiment of the present invention;

FIG. 2 is a perspective view of a slip unit of the slip control device of FIG. 1 according to an embodiment of the present invention;

FIG. 3 is a perspective view of a slip unit of the slip control device of FIG. 1 according to another embodiment of the present invention;

FIG. 4 is a perspective view of a slip unit of the slip control device of FIG. 1 according to another embodiment of the present invention;

FIG. 5 is a schematically perspective view of an operational state of the slip control device according to another embodiment of the present invention;

FIG. 6 is a schematically perspective view of an operational state of the slip control device of FIG. 5 when a driving unit is obstructed by an obstacle according to another embodiment of the present invention;

FIG. 7 is a perspective view of an operational state of a slip control device when there is no obstacle according to another embodiment of the present invention.

FIG. 8 is a perspective view of an operational state of the slip control device of FIG. 7 when a shaft is obstructed by an obstacle according to another embodiment of the present invention.

FIG. 9 is a schematic perspective view of a slip control device according to another embodiment of the present invention;

FIG. 10 is a bottom plan view of the slip control device of FIG. 9;

FIG. 11 is an exploded perspective view of a slip unit, a sensor unit, and a driving unit of FIG. 9;

FIG. 12 is an exploded perspective view of the slip unit of FIG. 11;

FIG. 13 is a block diagram of a control system according to an embodiment of the present invention;

FIG. 14 is a flowchart of a slip control method performed by a control system according to an embodiment of the present invention; and

FIG. 15 is a flowchart of a slip control method performed by a control system according to another embodiment of the present invention.

### MODE FOR THE INVENTION

Hereinafter, the present invention will be described in detail by explaining exemplary embodiments of the invention with reference to the attached drawings.

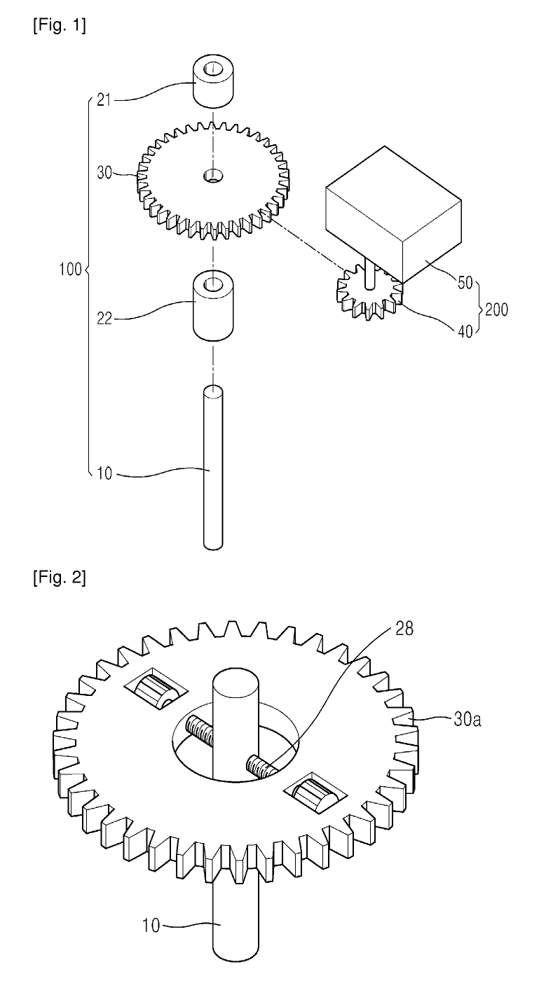

FIG. 1 is a schematic exploded perspective view of a slip control device according to an embodiment of the present invention. Referring to FIG. 1, the slip control device of the present embodiment includes a slip unit 100 and a driving unit 200. The slip unit 100 includes a shaft 10, a first friction unit 21, a second friction unit 22, and a first gear 30. The driving unit 200 includes a second gear 40 and a gear box 50.

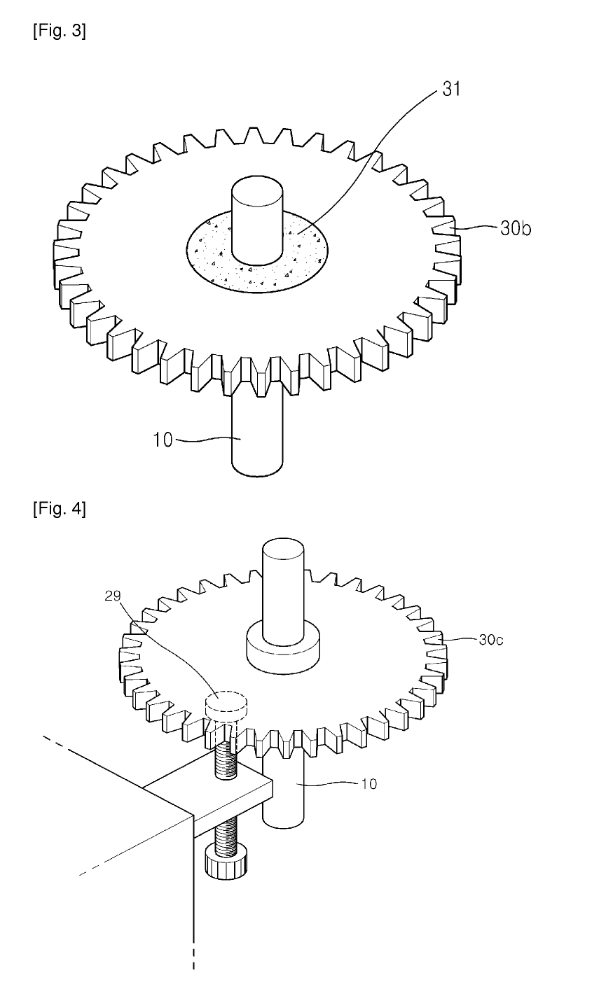

The first gear 30 of the slip unit 100 is disposed on the shaft 10 and is rotatably connected to the shaft 10. The first friction unit 21 and the second friction unit 22 may be disposed on the shaft 10 to provide a predetermined friction force in such a way that the first gear 30 is coupled to the shaft 10 by the friction force. Locations and shapes of the first friction unit 21 and the second friction unit 22 are not limited thereto and a variety of modifications that may be done thereon is obvious to one of ordinary skill in the art. For example, referring to FIG. 2, the first friction unit 21 and the second friction unit 22 may apply the friction force to the shaft 10 through a friction screw 28 disposed on a first friction gear 30a. Alternatively, referring to FIG. 3, an elastic gear unit 31 is disposed in a second friction gear 30b and disposed on the shaft 10. The elastic gear unit 31 is formed of elastic rubber and provides the friction force and may rotate by being applied a predetermined rotation force. An element used to fix the first gear 30 via the friction force is not limited to the shaft 10. Referring to FIG. 4, a fixing unit outside the shaft 10 may apply the friction force to a third friction gear 30c through an adjustment screw 29.

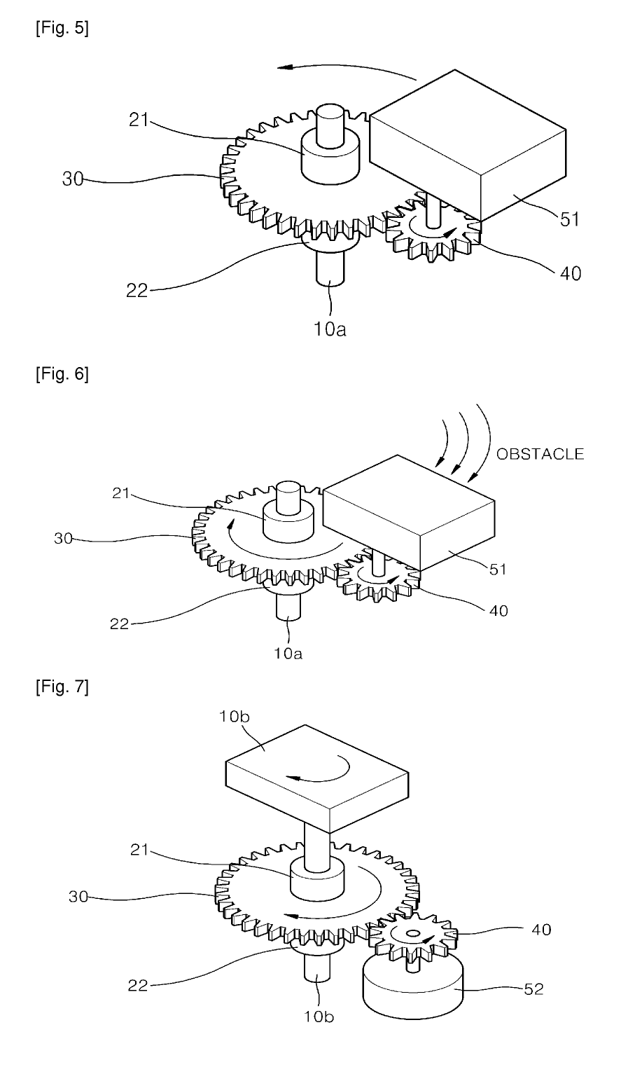

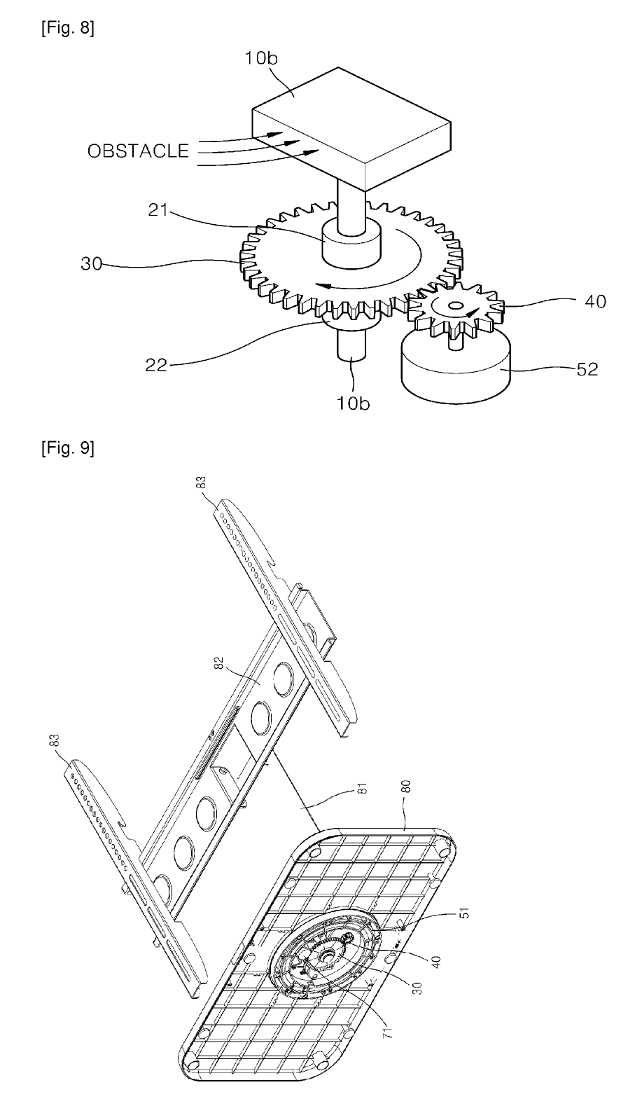

The driving unit 200 may mechanically transfer a rotation force of the second gear 40 to the first gear 30. The first gear 30 may rotate about the shaft 10 if a rotation force greater than a predetermined level is applied to the first gear 30. Such embodiments are shown in FIGS. 5 and 6 and in FIGS. 7 and 8.

FIG. 5 is a schematically perspective view of the slip control device according to another embodiment of the present invention. Referring to FIG. 5, the second gear 40 and a rotation gear box 51 rotate about the first gear 30. The first gear 30 is frictionally coupled to a fixing shaft 10a by the first friction unit 21 and the second friction unit 22. Since the first gear 30 is frictionally coupled to the fixing shaft 10a, if the second gear 40, which is engaged with the first gear 30, rotates, the second gear 40 rotates and turns around the first gear 30, that is, about the fixing shaft 10a. During the rotation and turning of the second gear 40 around the first gear 30, rotation of the rotation gear box 51 may be interrupted by an obstacle such as a user. In this regard, FIG. 6 is a schematically perspective view of the slip control device of FIG. 5 when the second gear 40 and the rotation gear box 51 is obstructed by an obstacle according to another embodiment of the present invention. When there is no obstacle, the rotation gear box 51 and the second gear 40 continuously rotate. At this time, a rotation force applied to the first gear 30 is smaller than a friction force between the first friction unit 21, the second friction unit 22, and the first gear 30, and thus the first gear 30 does not rotate about the fixing shaft 10a. However, if the rotation of the rotation gear box 51 is stopped due to an obstacle, the rotation force applied to the first gear 30 is greater than the friction force between the first friction unit 21, the second friction unit 22, and the first gear 30, and thus the first gear 30 starts rotating about the fixing shaft 10a. That is, the first gear 30 receives a rotation force greater than a predetermined level, and thus the first gear 30 rotates about the fixing shaft 10a, thereby acting as a safety device. More specifically, since the second gear 40 continuously rotates, if the first gear 30 does not start rotating around the fixing shaft 10a when the rotation gear box 51 contacts an obstacle, the rotation gear box 51 continues to rotate around the fixing shaft 10a, and thus the obstacle, such as a user, may be damaged. However, the present invention can prevent such damages by idling the first gear 30. Further, when the rotation gear box 51 stops due to an obstacle, if a rotation force is continuously applied to the second gear 40, a driving device may be overloaded. However, the present invention can prevent the overload by idling the first gear 30.

FIG. 7 is a perspective view of an operational state of a slip control device according to another embodiment of the present invention. Referring to FIG. 7, the slip control device includes a rotational shaft 10b, the first friction unit 21, the second friction unit 22, the first gear 30, the second gear 40, and a fixing gear box 52. The first gear 30 and the rotation shaft 10b rotate about the second gear 40. At this time, the fixing gear box 52 is fixed and the first gear 30 is frictionally coupled to the rotation shaft 10b by the first friction unit 21 and the second friction unit 22 so that the first gear 30 and the rotation shaft 10b rotate together. Since the fixing gear box 52 is fixed to a reference surface, if the second gear 40, which is engaged with the first gear 30, rotates, the first gear 30 rotates around the rotation shaft 10b that simultaneously rotates. Rotation of the rotation shaft 10b may be interrupted by an obstacle, such as a user.

FIG. 8 is a perspective view of an operational state of the slip control device of FIG. 7 when a rotation shaft 10b is obstructed by an obstacle according to another embodiment of the present invention. When there is no obstacle, the rotation shaft 10b, the first gear 30, and the second gear 40 rotate. At this time, a rotation force applied to the first gear 30 is less than a friction force between the first friction unit 21, the second friction unit 22, and the first gear 30, and thus the first gear 30 does not rotate about the fixing shaft 10b. If the fixing shaft 10b stops rotating due to an obstacle, the rotation force applied to the first gear 30 is greater than the friction force between the first friction unit 21, the second friction unit 22, and the first gear 30, and thus the first gear 30 starts rotating about the fixing shaft 10b.

The first gear 30 receives a rotation force greater than a predetermined level when the fixing shaft 10b is obstructed by an obstacle, which rotates the first gear 30 about the fixing shaft 10b, thereby acting as a safety device. More specifically, since the second gear 40 continuously rotates, if the first gear 30 does not start rotating around the fixing shaft 10b when the fixing shaft 10b encounters an obstacle, the fixing shaft 14b continues to rotate around the fixing gear box 52, and thus the obstacle, such as a user, may be damaged. Furthermore, when the fixing shaft 10b stops rotating due to an obstacle, a driving device, such as a motor, for generating the rotation force may be overloaded in order to continuously apply the rotation force to the second gear 40. In this case, when the rotation shaft 10b is obstructed by an obstacle, a rotation force greater than a predetermined level is applied to the first gear 30, and thus the first gear 30 rotates about the rotation shaft 10b obstructed by the obstacle, so that the slip control device of the present embodiment can prevent an accident.

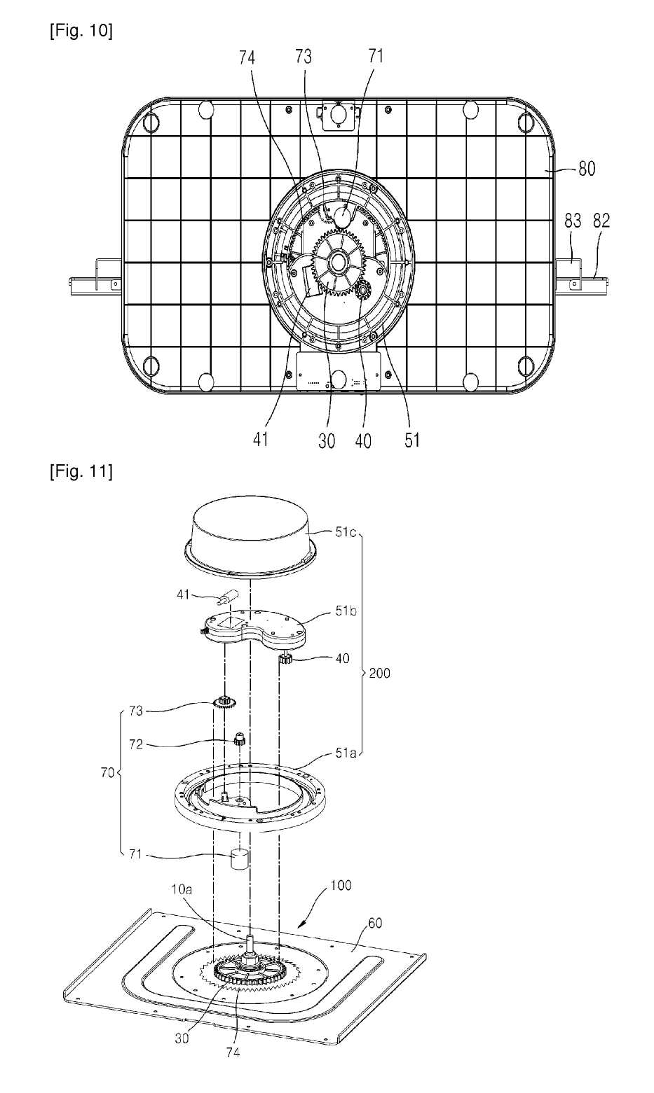

FIG. 9 is a schematic perspective view of a slip control device taken according to another embodiment of the present invention. FIG. 10 is a bottom plan view of the slip control device of FIG. 9. FIG. 11 is an exploded perspective view of the slip unit 100, a sensor unit 70, and a driving unit 200 of FIG. 9. Referring to FIGS. 5 through 7, the slip control device of the present embodiment is applied to a display panel rotation mounting device and includes the sensor unit 70, the slip unit 100, the driving unit 200, a support unit 81, a base bracket 82, and two mounting brackets 83. Referring to FIG. 11, the sensor unit 70 may include a sensor 71, a first sensor gear 72, and a second sensor gear 73. The driving unit 200 may include the second gear 40, a motor 41, a first rotation gear box 51a, a second rotation gear box 51b, and a third rotation gear box 51c.

The first rotation gear box 51a, the second rotation gear box 51b, and the third rotation gear box 51c may be coupled to each other through grooves as illustrated in FIG. 11 and may cover at least one surface of the first gear 30. The second rotation gear box 51b may rotate the second gear 40 through internal gears connected to the motor 41. The second gear 40 is engaged with the first gear 30 of the slip unit 100. Thus, as the motor 41 of the second gear box 51b rotates, the second gear 40 rotates, and thus the first gear 30 of the slip unit 100 engaged with the second gear 40 rotates. At this time, since the first gear 30 of the slip unit 100 is frictionally coupled to the fixing shaft 10a by a friction force, the second gear 40 rotates and turns around the first gear 30, that is, about the fixing shaft 10a. As the second gear 40 rotates and turns around the first gear 30, the first rotation gear box 51a, the second rotation gear box 51b to which the second gear 40 is coupled, and the third rotation gear box 51c also rotate about the fixing shaft 10a of the slip unit 100. Referring to FIG. 9, the support unit 81, the base bracket 82, and the mounting brackets 83 connected to the first rotation gear box 51a, the second rotation gear box 51b, and the third rotation gear box 51c rotate about the fixing shaft 10a with respect to first and second fixing units 60 and 80. According to the above-mentioned structure, the mounting brackets 83 rotate so that a user can easily adjust a rotational angle of a display device according to the user's convenience. If the display device stops rotating due to being obstructed by an obstacle, such as a child, the first rotation gear box 51a, the second rotation gear box 51b, and the third rotation gear box 51c stop rotating, and the second gear 40 applies a rotation force greater than the friction force between the first gear 30 and the fixing shaft 10a to the first gear 30 of the slip unit 100. If the first rotation gear box 51a, the second rotation gear box 51b, and the third rotation gear box 51c stop rotating, since the second gear 40 applies a rotation force greater than the friction force between the first friction unit 21, the second friction unit 22, and the first gear 30, the first gear 30 idles about the fixing shaft 10a. Thus, the slip unit 100 acts as a safety device that may not overload the motor 41 of the driving unit 200.

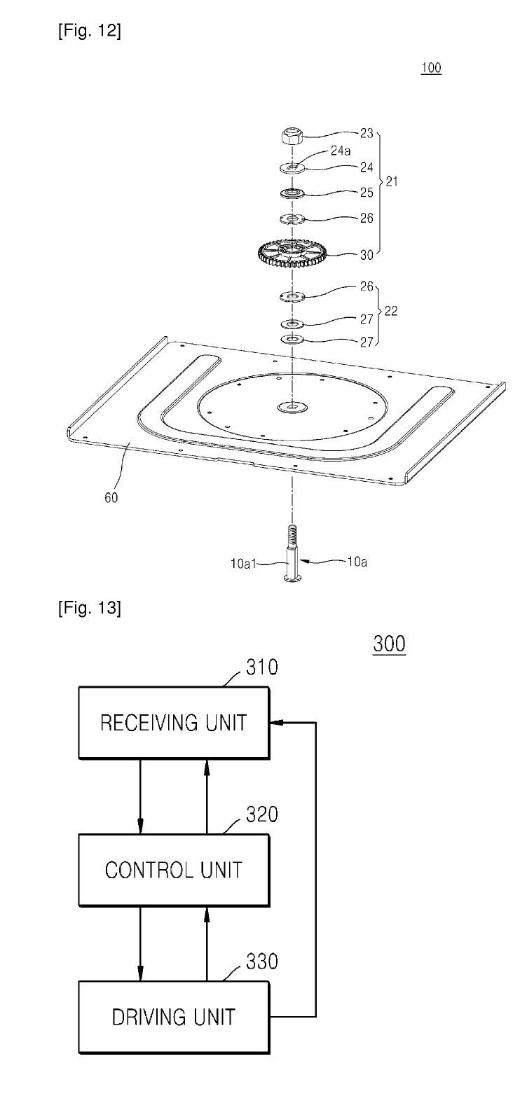

FIG. 12 is an exploded perspective view of the slip unit 100 of FIG. 11. Referring to FIG. 12, the slip unit 100 may include the first friction unit 21, the second friction unit 22, the first gear 30, the fixing shaft 10a, and the first fixing unit 60. Here, the fixing shaft 10a has a fixing washer projection 10a1 on an external contact surface. The first friction unit 21 may include a friction adjustment nut 23, a fixing washer 24, a plate spring washer 25, and a gear support 26. Here, the fixing washer 24 may be disposed on one side of the friction adjustment nut 23. The fixing washer 24 has a through-hole 24a disposed therein. The shape of the through-hole 24a may correspond to that of the fixing washer projection 10a1 of the shaft 10. The fixing washer may be hooked on the fixing washer projection 10a1 of the shaft 10. The second friction unit 22 may include another gear support 26 and a plurality of spacers 27. The fixing shaft 10a is fixed to the first fixing unit 60. The first gear 30 is frictionally coupled to the first fixing unit 60 by the first friction unit 21 and the second friction unit 22. If the second gear 40 applies a rotation force greater than a friction force between the first and second friction units 21 and 22 and the first gear 30 to the first gear 30, a slip occurs between the fixing washer 24 and the plate spring washer 25 and between the spacers 27 and thus the first gear 30 rotates about the fixing shaft 10a.

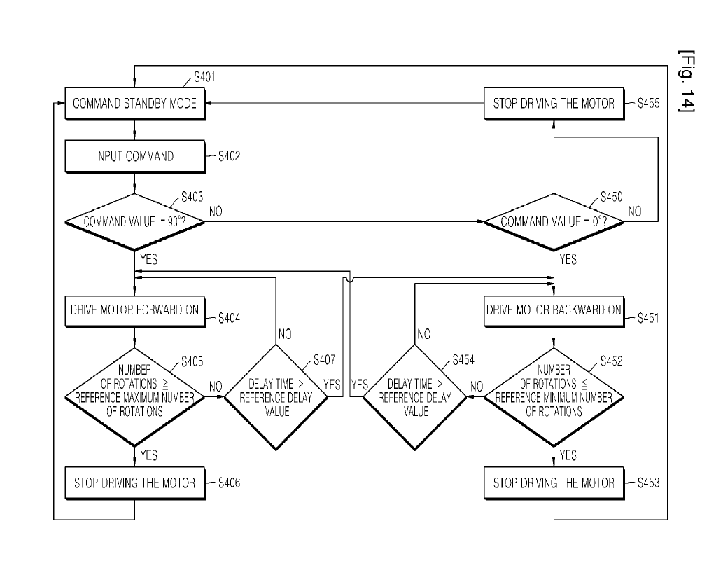

A rotational angle of each of the first rotation gear box 51a, the second rotation gear box 51b, and the third rotation gear box 51c may be controlled by a control system 300. Referring to FIG. 13, the control system 300 may include a receiving unit 310, a control unit 320, and a driving unit 330. The receiving unit 310 detects the rotational angle of each of the first rotation gear box 51a, the second rotation gear box 51b, and the third rotation gear box 51c with respect to the first and second fixing units 60 and 80. The control unit 320 receives the rotational angle of each of the first rotation gear box 51a, the second rotation gear box 51b, and the third rotation gear box 51c detected by the receiving unit 310 and outputs a control value. The driving unit 330 receives the control value output by the control unit 320 and drives the motor 41.

Although the receiving unit 310 of the control system 300 may include, for example, the sensor unit 70 as shown in FIG. 10, the present invention is not limited thereto. A variety of modifications that may be done to the receiving unit 310 is obvious to one of ordinary skill in the art.

The sensor unit 70 may includes the sensor 71, the first sensor gear 72, and the second sensor gear 73, and senses the rotational angle of each of the first rotation gear box 51a, the second rotation gear box 51b, and the third rotation gear box 51c about the first and second units 60 and 80. Referring to FIG. 10, the second sensor gear 73 is engaged with a fixing gear 74 fixed to the first fixing unit 60 of the slip unit 100, in which the first rotation gear box 51a, the second rotation gear box 51b, and the third rotation gear box 51c rotate, and thus the second sensor gear 73 rotates around the inside a fixing gear 74. If the second sensor gear 73 rotates, the first sensor gear 72 engaged with the second sensor gear 73 rotates. At this time, the sensor 71 measures the number of rotations of the first rotation gear box 51a, the second rotation gear box 51b, and the third rotation gear box 51c, thereby detecting the rotational angle of each of the first rotation gear box 51a, the second rotation gear box 51b, and the third rotation gear box 51c about the first and second fixing units 60 and 80. For example, if an allowable rotational angle of each of the first rotation gear box 51a, the second rotation gear box 51b, and the third rotation gear box 51c about the first and second units 60 and 80 is 90 degrees the first sensor gear 72 may rotate one full time each time the first rotation gear box 51a, the second rotation gear box 51b, and the third rotation gear box 51c rotate by 10 degrees. In this manner, the rotational angle of each of the first rotation gear box 51a, the second rotation gear box 51b, and the third rotation gear box 51c about the first and second units 60 and 80 may be detected. For example, if the first sensor gear 72 rotates four times, the rotational angle of each of the first rotation gear box 51a, the second rotation gear box 51b, and the third rotation gear box 51c about the first and second units 60 and 80 rotate by 40 degrees about the first and second units 60 and 80

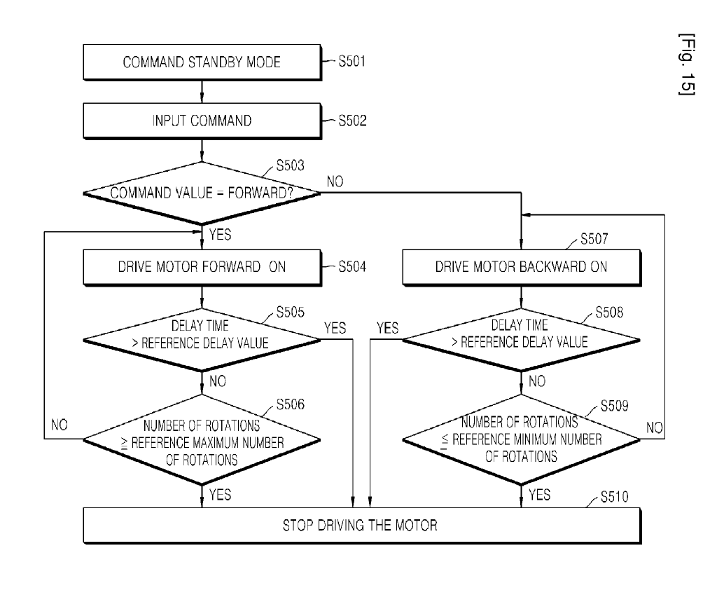

FIG. 14 is a flowchart of a method of controlling the rotational angle of each of the first rotation gear box 51a, the second rotation gear box 51b, and the third rotation gear box 51c using the control system 300 according to an embodiment of the present invention. In the present embodiment, an initial value of the control system 300 is set as 0 degree if the control system 300 receives a command, the control system 300 rotates by 90 degrees If the control system 300 faces an obstacle during its rotation, the control system 300 returns to the initial value before receiving further instructions. However, the present invention is not limited thereto and a variety of modifications that may be done to the control system 300 is obvious to one of ordinary skill in the art.

Referring to FIG. 14, the control system 300 maintains a command standby mode (operation S401) before receiving a command. At this time, a user may send one of three commands such as a rotation of 90 degrees a rotation to 0 degree and a stop command. The rotation of 90 degrees indicates rotations of the first rotation gear box 51a, the second rotation gear box 51b, and the third rotation gear box 51c by 90 degrees from a reference location. The rotation to 0 degrees indicates restoration of the first rotation gear box 51a, the second rotation gear box 51b, and the third rotation gear box 51c that have rotated by 90 degrees to the reference location. The stop command indicates stopping of driving of the control system 300. If the control system 300 receives a command (operation S402), the control system 300 determines whether the received command indicates the rotation of 90 degrees (operation S403). If the command is determined to indicate the rotation of 90 degrees the motor 41 starts driving in a forward rotation direction (operation S404).

The control system 300 determines the number of rotations sensed by the sensor 71 (operation S405). The sensor 71 may have a maximum number of rotations and a minimum number of rotations as reference values with respect to a forward direction and a backward direction using a predetermined limited range of a rotational angle. For example, although the first rotation gear box 51a, the second rotation gear box 51b, and the third rotation gear box 51c can rotate by 110 degrees about the first and second fixing units 60 and 80, the first rotation gear box 51a, the second rotation gear box 51b, and the third rotation gear box 51c substantially rotate between 20 degrees and 90 degrees. At this time, when the first sensor gear 72 is adjusted to rotate one full time whenever the first rotation gear box 51a, the second rotation gear box 51b, and the third rotation gear box 51c rotate by 10 degrees the minimum number of rotations is often 2, the maximum number of rotations is often 9, and the maximum number of rotations can be at most 11. Thus, the sensor 71 determines whether the number of rotations is the same as or greater than a reference maximum number of rotations (operation S405). A variety of modifications that may be done thereon is obvious to one of ordinary skill in the art. For example, when the first sensor gear 72 substantially rotates one full time, each time the rotation gear box rotates by 15 degrees with respect to the reference surface. If the number of rotations is the same as or greater than the reference maximum number of rotations, the motor 41 stops driving (operation S406), and the control system 300 returns to the command standby mode (operation S401).

When the sensor 71 measures the number of rotations, the first rotation gear box 51a, the second rotation gear box 51b, and the third rotation gear box 51c may be interrupted by an obstacle. In this case, the sensor 71 calculates a delay time in which the number of rotations does not increase over a predetermined number of rotations, and, if the delay time is longer than a predetermined reference delay value, rotates the motor 41 backward (operation S407).

When the control system 300 receives a command (operation S402) and determines whether the received command indicates the rotation of 90 degrees (operation S403), if the command indicates the rotation to 0 degree (operation S450), the control system 300 rotates the motor 41 backward (operation S451). In this case, for example, after the first rotation gear box 51a, the second rotation gear box 51b, and the third rotation gear box 51c rotate by 90 degrees a user may attempt to restore the first rotation gear box 51a, the second rotation gear box 51b, and the third rotation gear box 51c to their original locations.

The sensor 71 determines whether the number of rotations of the first sensor gear 72 is the same as or less than a reference minimum rotation number (operation S452). If the number of rotations of the first sensor gear 72 is the same as or less than the reference minimum rotation number, the control system 300 stops driving (operation S453) and returns to the command standby mode (operation S401).

When the sensor 71 measures the number of rotations, the first rotation gear box 51a, the second rotation gear box 51b, and the third rotation gear box 51c may be interrupted by an obstacle. In this case, the sensor 71 calculates a delay time in which the number of rotations does not increase over a predetermined number of rotations, and, if the delay time is longer than a predetermined reference delay value, the control system 300 determines that the first rotation gear box 51a, the second rotation gear box 51b, and the third rotation gear box 51c are obstructed by an obstacle, rotates the motor 41 forward, thereby rotating the first rotation gear box 51a, the second rotation gear box 51b, and the third rotation gear box 51c in a direction away from the obstacle (operation S454).

When the control system 300 receives a command (operation S402) and determines whether the received command value indicates the rotation of 90 degrees (operation S403), if the command does not indicate the rotation of 90 degrees or the rotation to 0 degree (operation S450), the motor 41 stops driving (operation S455) and the control system 300 returns to the command standby mode (operation S401).

The present invention is not limited to the control system 300 of the present embodiment and a variety of modifications thereof that may be performed thereon is obvious to one of ordinary skill in the art. For example, FIG. 15 shows an algorithm of stopping rotation of the motor 41 and rotations of the first rotation gear box 51a, the second rotation gear box 51b, and the third rotation gear box 51c by using the control system 300 when the first rotation gear box 51a, the second rotation gear box 51b, and the third rotation gear box 51c face an obstacle.

The control system 300 maintains a command standby mode (operation S501) before receiving a command, receives an input of the command (operation S502), and determines whether the command indicates a forward rotation (operation S503). If the command value indicates the forward rotation, the motor 41 starts driving forward (operation S504). If the command indicates a backward rotation, the motor 41 starts driving backward (operation S507).

If the motor 41 stops forward driving due to being obstructed by an obstacle, the sensor 71 calculates a delay time in which the number of rotations does not increase over a predetermined number of rotations, and compares the delay time with a predetermined reference delay value (operation S505). If the delay time is longer than the predetermined reference delay value, the control system 300 stops driving the motor 41 (operation S510). If the delay time is shorter than the predetermined reference delay value, the control system 300 continuously driving the motor 41 forward until the number of rotations detected by the sensor 71 is the same as or greater than a reference maximum number of rotations (operation S506). If the number of rotations detected by the sensor 71 is greater than the reference maximum number of rotations, the sensor 71 detects that the first rotation gear box 51a, the second rotation gear box 51b, and the third rotation gear box 51c have rotated by a rotational angle desired by a user and the motor 41 stops driving forward (operation S510). If the number of rotations detected by the sensor 71 is less than the reference maximum number of rotations, the sensor 71 detects that the first rotation gear box 51a, the second rotation gear box 51b, and the third rotation gear box 51c have not rotated by the rotational angle desired by the user (operation S506) and the motor 41 drives forward (operation S504).

An algorithm similar to that for driving the motor 41 forward may be applied to the motor 41 to drive the motor 41 backward (operation S507). In more detail, when the motor 41 while driving backward is delayed by an obstacle, the control system 300 compares a delay time in which the number of rotations does not increase over a predetermined number of rotations with a predetermined reference delay value (operation S508), if the delay time is greater than the predetermined reference delay value, the sensor 71 detects that the first rotation gear box 51a, the second rotation gear box 51b, and the third rotation gear box 51c have stopped rotating due to an obstacle and the motor 41 stops driving (operation S510). If the delay time is less than the predetermined reference delay value, the motor 41 continuously drives backward. The sensor 71 determines whether the number of rotations is less than a reference minimum number of rotations (operation S509). If the number of rotations is less than the reference minimum number of rotations, the sensor 71 detects that the first rotation gear box 51a, the second rotation gear box 51b, and the third rotation gear box 51c have rotated backward as desired by a user and the motor 41 stops driving backward (operation S510). If the number of rotations is not less than the reference minimum number of rotations, the sensor 71 detects that the first rotation gear box 51a, the second rotation gear box 51b, and the third rotation gear box 51c have not rotated backward and the motor 41 is continuously drives backward (operation S507).

The driving of the slip unit 100 is not limited thereto and a variety of applications thereof is obvious to one of ordinary skill in the art. For example, the slip unit 100 may include a direction switch function of a rotation tube of a washing machine, a fan, and the like and may not be limited thereto. The present invention can be used for all industries of manufacturing using a slip control device.

While this invention has been particularly shown and described with reference to exemplary embodiments thereof, it will be understood by those of ordinary skill in the art that various changes in form and details may be made therein without departing from the spirit and scope of the invention as defined by the appended claims.

1. A slip control device comprising:
a shaft fixed to a reference surface;
a first gear rotatably coupled to the shaft by a predetermined friction force with respect to an external circumferential surface of the shaft, for slipping with respect to the shaft when applied a rotation force greater than the predetermined friction force;
a friction unit configured to provide the predetermined friction force between the first gear and the shaft;
a rotation gear box for covering at least one surface of the first gear, coupled to a second gear to be rotated around the external circumferential surface of the shaft, and for rotating about the shaft during rotation of the second gear; and
a motor disposed in the rotation gear box and providing the second gear with a rotation force to rotate the rotation gear box about the first gear.

2. The slip control device of claim 1, further comprising:
a support unit attached to the rotation gear box and for rotating during the rotation of the rotation gear box;
a base bracket coupled to the support unit; and
a mounting bracket pivotally coupled to the base bracket and for mounting a unit to be attached.

3. The slip control device of claim 1, wherein the shaft comprises a fixing washer projection on an external contact surface thereof, wherein the friction unit comprises:
a friction adjustment nut screwed onto the shaft;
a fixing washer disposed on one side of the friction adjustment nut and hooked on the fixing washer projection of the shaft; and
a washer disposed on the shaft between the friction adjustment nut and the first gear and providing the first gear with the predetermined friction force.

4. The slip control device of claim 2, further comprising: a control system for controlling a rotational angle of the support unit with respect to the reference surface,
wherein the control system comprises:
a receiving unit for detecting a change in an angle of the support unit with respect to the reference surface;
a control unit for receiving the change in the angle of the support unit with respect to the reference surface detected by the receiving unit and outputting a control value; and
a driving unit for receiving the control value and rotating the motor, wherein the receiving unit comprises:
a second sensor gear mechanically engaged with an internal circumferential surface of a fixing gear located in the reference surface and rotating around the fixing gear during the rotation of the rotation gear box;
a first sensor gear engaged with the second sensor gear and rotating around the second sensor gear; and
a sensor mechanically coupled to the first sensor gear on a rotating axis of the first sensor gear, and detecting the change in the angle of the support unit with respect to the reference surface during rotation of the first sensor gear,
wherein the sensor is disposed in the rotation gear box.

5. The slip control device of claim 4, wherein the first sensor gear substantially rotate one full time each time the rotation gear box rotates by 15 degrees with respect to the reference surface.

6. The slip control device of claim 4, wherein the control unit receives a command from a user, and operates the driving unit to rotate the support unit with respect to the reference surface, and, if a delay time in which a change in the angle of the support unit detected by the receiving unit does not occur is greater than a first reference value during the operation of the driving unit, stops operating the driving unit.

7. The slip control device of claim 4, wherein the control unit receives a command from a user, and operates the driving unit to rotate the support unit in a direction with respect to the reference surface, and, if a delay time in which a change in the angle of the support unit detected by the receiving unit does not occur is greater than a second reference value during the operation of the driving unit, rotates the support unit in an opposite direction.
